(19) United States
(12) Patent Application Publication
(10) Pub. No.: US 2014/0274026 A1
(43) Pub. Date: Sep. 18, 2014

(54) LIMITING MOBILE DEVICE FUNCTIONALITY IN A VEHICLE

(71) Applicant: Cbros Technologies, LLC, Winter Park, FL (US)

(72) Inventors: Stephen Nelson Mahar, Eliot, ME (US); Donald Edward Wiiliams, Jr., Winter Park, FL (US)

(73) Assignee: CBROS TECHNOLOGIES, LLC, Winter Park, FL (US)

(21) Appl. No.: 14/212,740

(22) Filed: Mar. 14, 2014

Related U.S. Application Data
(60) Provisional application No. 61/801,025, filed on Mar. 15, 2013.

(51) Int. Cl. H04W 8/22

(52) U.S. Cl. CPC H04W 8/22
USPC 455/419

(57) ABSTRACT

A method, device, and system for limiting mobile device functionality in a vehicle. When a vehicle is operational (turned on with the transmission engaged), a disabling device, connected to the OBD port of the vehicle, transmits a disabling signal that is received and processed by software residing on a mobile device. Upon receipt and validation of the disabling signal, the software will alter the mobile device's system configuration to, for example, remove the ability of the mobile device to send and/or receive text and/or e-mail messages for as long as the disabling signal is transmitted. Once the disabling device detects that the vehicle is no longer operational, the disabling device ceases transmission of the disabling signal. After a predetermined time of not receiving a disabling signal, the software restores the mobile device's system configuration to its original configuration.

### CROSS-REFERENCE TO RELATED APPLICATION

This application claims priority to U.S. Provisional Patent Application No. 61/801,025, filed Mar. 15, 2013, entitled “Method and System for Limiting Mobile Device Functionality in a Vehicle”, which is hereby incorporated by reference herein in its entirety.

### FIELD OF INVENTION

The present disclosure generally relates to mobile devices and vehicles; more specifically, to detecting a vehicle diagnostic indicative of the operation status of a vehicle and altering the operating state of the mobile device based on the vehicle diagnostic.

### BACKGROUND

The personal, societal, and economic impacts of texting while driving are well chronicled. Studies show that texting while driving increases the risk of an accident by 2300%. Texting while driving resulted in 16,141 deaths in the U.S. between 2001 and 2007, and in 2009, 5,474 people were killed in the U.S. because of accidents that involved distracted driving. Another 448,000 were injured.

Younger generations have grown up using texting and email from a very young age. Most teenagers send hundreds, if not thousands, of texts each week, making it their primary form of communication. It is an engrained habit. Stepping away from it voluntarily, even when presented with the dangers to themselves and others they may impact, is very difficult. The increasing amount of accidents, cost, injuries, and deaths is alarming.

Current systems have attempted to address this issue but have major drawbacks. Such drawbacks include reliance on multiple voluntary actions by the driver and/or reliance on the motion of the vehicle (i.e. a certain minimum speed). There are many documented crashes involving a driver texting while driving at a slow speed, such as rolling slowly through a stop or red light into an intersection. Some systems rely on wireless transmissions, such as Bluetooth®, that require synchronization with each vehicle. Some systems also gather driver performance data, such as speed or number of hard stops. Such systems may be considered intrusive on the driver's privacy. Many systems can be readily defeated by a driver determined to do so. In addition, some systems' components can be disabled without accountability to a monitoring entity.

As such, there is a need in the art for a system that can automatically limit mobile device functionality, including the ability to text, when a vehicle is in operation.

### SUMMARY

In accordance with the teachings disclosed herein, embodiments related to a method, device, and system for limiting mobile device functionality in a vehicle are disclosed. The method, device, and system work with the vehicle's on-board diagnostic (OBD) system.

In an embodiment, a method includes receiving a vehicle diagnostic signal from the vehicle's OBD system. The vehicle diagnostic signal is received by a disabling device that is in communication with the vehicle OBD system and a mobile device. Once a vehicle diagnostic signal is received, the vehicle's operational status is determined from the vehicle diagnostic signal. The receipt of a vehicle diagnostic and determination of the vehicle's operational status repeats continuously while the operational status is non-operational. When the vehicle's operation status is operational, a disabling signal is transmitted to the mobile device. The disabling signal limits the functionality of the mobile device.

In another embodiment, a method includes polling, at a mobile device, for a disabling signal. The disabling signal originates at a disabling device that is in communication with a vehicle's OBD system. Once a disabling signal is received and it is determined that the disabling signal is valid, the mobile device's system configuration is altered. The mobile device continues polling for the disabling signal. The mobile device's system configuration is restored when the disabling signal is not received for a pre-determined amount of time.

In an additional embodiment, the disabling device includes an OBD interface, a microcontroller, and a wireless network radio. The OBD interface is capable of communicating with the OBD system. The microcontroller, which is in communication with the OBD interface, receives a vehicle diagnostic from the OBD system through the OBD interface. The wireless network radio, which is in communication with the microcontroller, transmits a disabling signal when it receives the vehicle diagnostic indicating that the vehicle' operational status is operational.

In a further embodiment, the system includes a disabling device and a mobile device. The disabling device has an OBD interface, a microcontroller, and a wireless network radio. The OBD interface is capable of communicating with the OBD system. The microcontroller, which is in communication with the OBD interface, receives a vehicle diagnostic from the OBD system through the OBD interface. The wireless network radio, which is in communication with the microcontroller, transmits a disabling signal when it receives the vehicle diagnostic indicating that the vehicle' operational status is operational. The mobile device receives the disabling signal. The software residing on the mobile device alters the mobile device's system configuration.

### BRIEF DESCRIPTION OF THE DRAWINGS

FIG. 1 is a block diagram of a system for limiting mobile device functionality in a vehicle having an OBD system according to an embodiment of the present invention.

FIG. 2A is a perspective view of an interior portion of the driver's side of an exemplary vehicle illustrating the location of an onboard diagnostic (OBD) system port.

FIG. 2B is an exploded, front-side perspective view of a disabling device and its connections to a vehicle's OBD system on the backside and its connections to an OBD system's tool on the front side according to an embodiment of the present invention.

FIG. 2C is a backside perspective view of the disabling device shown in FIG. 2B according to an embodiment of the present invention.

FIG. 3 is a flowchart of a method of limiting mobile device functionality in a vehicle from the perspective of the disabling device according to an embodiment of the present invention.

FIG. 4 is a flowchart of a method of limiting mobile device functionality in a vehicle from the perspective of the disabling device according to another embodiment of the present invention.

FIG. 5 is a flowchart of a method of issuing monitoring alerts from the perspective of the disabling device according to an embodiment of the present invention.

FIG. 6 is a flowchart of method of monitoring three exemplary events from the perspective of the disabling device according to an embodiment of the present invention.

FIG. 7 is a block diagram illustrating an exemplary mobile device on which at least a portion of the method of limiting mobile device functionality in an operating vehicle may occur according to an embodiment of the present invention.

FIG. 8 is a flowchart of a method of limiting device functionality in an operating vehicle from the perspective of the mobile device according to an embodiment of the present invention.

FIG. 9 is a flowchart of a method of limiting mobile device functionality in a vehicle from the perspective of the mobile device according to an embodiment of the present invention.

FIG. 10 is a flowchart of a method of issuing monitoring alerts from the perspective of the mobile device according to another embodiment of the present invention.

### DETAIL DESCRIPTION OF THE EMBODIMENTS

A detailed description of the embodiments for a system, device, and method for limiting mobile device functionality in an operating vehicle having an OBD system will now be presented with reference to FIGS. 1-10. One of skill in the art will recognize that these embodiments are not intended to be limitations on the scope, and that modifications are possible without departing from the spirit thereof. In certain instances, well-known methods, procedures, components, and circuits have not been described in detail.

In an embodiment, as shown in FIG. 1, system 100 includes disabling device 101 and mobile device 102. Disabling device 101 includes OBD system interface 103, processor or microcontroller unit (MCU) 104 in communication with OBD system interface 103, cellular radio 105 in communication with MCU 104, wireless network radio 106 in bi-directional communication with MCU 104, and OBD tool interface 107 in bi-directional communication with OBD system interface 103. Mobile device 102, further shown and described below and in FIG. 7, has a software application, or app, residing thereon that is capable of receiving a disabling signal from disabling device 101.

OBD system interface 103 can physically engage with vehicle's OBD system 110 and is capable of by bi-directional communication therewith. While the host vehicle is turned on, vehicle's OBD system 110 continuously sends out a signal containing data that includes vehicle diagnostic information, such as the vehicle's transmission status, movement status (e.g. forward motion or backward motion), speed, and acceleration. When engaged, OBD system interface 103 draws power from a battery pin (not shown) on OBD system 110 and receives the OBD signal. OBD system interface 103 transmits the OBD signal to MCU 104. Upon arrival at MCU 104, the OBD signal is converted into a signal readable by MCU 104. This can be accomplished, for example, through the use of UART/SPI (universal asynchronous receiver/transmitter/serial) peripheral interface technology. Alternatively, conversion can also take place at OBD system interface 103.

MCU 104 uses the vehicle diagnostic information obtained from the OBD signal to determine the vehicle's operational status. If the vehicle is operational, MCU 104, instructs wireless network device 106 to broadcast a disabling signal. MCU 104 can interface with wireless network device 106, which may be, for example, a 802.11 radio, via any known mechanism, for example UART. As used herein, the term ‘operational’ means that the vehicle is turned on and that the transmission has been engaged (e.g. the vehicle is not in park or in neutral, the vehicle has forward motion, the vehicle has backward motion, the vehicle has reached a threshold speed, the vehicle has reached a threshold acceleration or a combination thereof). The term “non-operational”, as used herein, means that the vehicle is turned on but the transmission is not engaged (e.g. the vehicle is running but in park, the vehicle is running but in neutral, or the vehicle is running but not moving). If the vehicle is non-operational, MCU 104 continues receiving and processing the vehicle's diagnostic information awaiting a vehicle diagnostic that indicates the vehicle's status is operational. If a disabling signal has been broadcast and mobile device 102 is in range of the broadcasting signal, the software residing on mobile device 102 will alter the system configuration of mobile device 102 to restrict the user's ability to perform certain tasks including, for example, using the keyboard, or sending and/or receiving text messages, email messages, and/or phone calls. Use of some features, such as maps, dialing 911, and voice-activated calling can still be permitted. Broadcast of the disabling signal will continue or be performed at regular intervals (e.g. every 20 seconds) until the vehicle's status becomes non-operational. The disabling signal can be, for example, a service set identifier (SSID) or an encrypted SSID and can be secured via Wi-Fi protected access 2/advanced encryption standard (WPA2/AES) encryption or similar known techniques. The broadcasting range of the disabling signal can be limited to only encompass the driver area or vehicle (e.g. 3-10 feet). The broadcast of the disabling signal may continue after the operational status of the vehicle becomes non-operational for a predetermined amount of time (e.g. one to two minutes).

MCU 104 ensures disabling device 101's operation by checking for connectivity to vehicle's OBD system 110. This can be accomplished with internal programming and/or a physical or software switch. In addition, MCU 104 monitors vehicle's OBD system 110 for a power supply.

System 100 can further include monitoring party's device 111. Cellular radio 105 communicates wirelessly with monitoring party's device 111. Monitoring party's device 111 can monitor the status of disabling device 101 and the app running on mobile device 102. Cellular radio 105 can use GSM/GPRS (global system for mobile communications/general packet radio service) or any other known transmission service. Cellular radio 105 may include a subscriber identity module (SIM) card and may only be equipped with SMS text capabilities. Cellular radio 105, at the direction of MCU 104, can send messages/alerts, such as, for example a short message service (SMS) push notification containing the VIN number and disabling device MAC ID address, to monitoring party's device 111, when certain events occur. For example, an alert may be sent when disabling device 101 is plugged into a vehicle, when disabling device 101 is unplugged from a vehicle, or when there is no external power to disabling device 101 for a predetermined amount of time (e.g. one (1) to two (2) minutes) when host vehicle is running. The app running on mobile device 102 can also send notifications, such as ‘app installed’, ‘app disabled’, or ‘app functioning normally’, to monitoring party's device 111. The notifications and alerts from the app include mobile device 102's phone number. A monitoring party may be an insurance company or a concerned parent. Monitoring party's device 111 enables the monitoring party to verify that disabling device 102 and the app running on mobile device 102 are operable.

Disabling device 101 can also include backup power source 108, such as a battery, connected to cellular radio 105 and MCU 104. Backup power source 108 allows cellular radio 105 to transmit an alert to monitoring party's device 111 in the event disabling device 101 is unplugged from the host vehicle and, therefore, disconnected from vehicle's OBD system 110's power supply.

MCU 104 may also store information related to the driver/user or to the vehicle disabling device 101 is attached to. Such information may include the account number and name of the user and the make, year, and/or model of the vehicle. Such information can also be transmitted, as needed, via cellular radio 103 to, for example, monitoring party's device 111, or via wireless network device 106 to, for example, mobile device 102.

OBD Tool interface 107 allows OBD Tool 112, such as a standard OBD plug used to collect vehicle diagnostic from a vehicle, to plug into disabling device 101 just as it would plug directly into OBD system 110. For this function, disabling device 101 serves as a pass-through device allowing bi-directional communication between OBD tool 112 and vehicle's OBD system 110 through OBD tool interface 107 and OBD interface 107. This allows the typical function of vehicle's OBD system 110 to be performed by connecting OBD tool 112 without removing or disrupting disabling device 101. This will prevent a bad actor from inaccurately claiming his or her device was removed for vehicle service.

System 100 can further include remote server 113 having a database (whitelist) containing a list of media access control (MAC) addresses or other unique identifier assigned to the wireless network device of each disabling device in operation. Remote server 113 is in bi-directional, wireless communication with mobile device 102. This list, or whitelist, can be queried by the software running on a mobile device to determine if a received disabling signal is coming from a valid source. This will prevent a bad actor from attempting to disable a phone by sending a disabling signal from an unauthorized device.

FIG. 2A shows an interior portion of an exemplary host vehicle illustrating an exemplary location of vehicle's OBD system 110's port. Although the interior of a car is shown in FIG. 2A, embodiments of the present invention can be installed in all types of vehicles including trucks, buses, cars, motorcycles, trains and other motor vehicles. For vehicles such as trains where an OBD system may not be available, an equivalent vehicle parameter system can be used.

An embodiment of disabling device 101 is shown in FIGS. 2B and 2C. FIG. 2B illustrates the ability of disabling device 101 to interface with OBD tool 112 via OBD tool interface 107. OBD tool interface 107 can be an exterior plug-in, such as a 16-pin OBD II plug-in. OBD tool interface 107 is on a side of disabling device 101 opposite or adjacent to OBD system interface 103 (FIG. 2C), which connects to vehicle's OBD system 110. This configuration allows traditional vehicle diagnostic work to be performed on the host vehicle without having to remove disabling device 101. OBD tool 107 can simply be plugged into OBD tool interface 107 while disabling device 101 is plugged into vehicle's OBD system 110.

The disabling device is shown and describe in FIGS. 2A though 2C as an external plug-in device; however, the disabling device can also be pre-installed during manufacturing. The disabling device can be installed outboard of the vehicle's OBD port (as a permanently attached plug-in) or in-board (attached directly into parameter feeds of the vehicle's diagnostic system).

An embodiment of the method of the present invention from the perspective of disabling device 101 (method 300) is illustrated in the flowchart in FIG. 3. As shown in operation 305, disabling device 101 receives vehicle diagnostic information from vehicle's OBD system 110. Then, in operation 310, disabling device 101 determines the vehicle's operational status from the vehicle diagnostics. If, in operation 315, the operational status is non-operational, disabling device 101 continues receiving vehicle diagnostic information from vehicle's OBD system 110. Otherwise, disabling device 101, in operation 320, transmits a disabling signal using wireless network device 106. Disabling device 101 then repeats the process. Optionally, disabling device 101 can, in operation 325, wait a predetermined amount of time before repeating this process.

Another embodiment of the method of the present invention from the perspective of disabling device 101 (method 400) is illustrated in the flowchart of FIG. 4. As shown, method 400 begins initially with the disabling signal turned off. In operation 405, disabling device 101 receives vehicle diagnostic information from vehicle's OBD system 110. Then, in operation 410, disabling device determines the vehicle's operational status from the vehicle diagnostics. If, in operation 415, the operational status is operational, disabling device 101, in operation 420, transmits a disabling signal using wireless network device 106. Broadcast of the disabling signal continues while the vehicle is operational. Disabling device 101 then repeats the process. Optionally, disabling device 101 can, in operation 425, wait a predetermined amount of time before repeating this process. If, in operation 415, the operational status is non-operational, then disabling device 101, in operation 430, determines if the disabling signal is turned on. If the disabling signal is off, then the process repeats. If the disabling signal is on, then it is turned off in operation 440 and the process repeats. Optionally, disabling device 101 can, in operation 440, wait a predetermined amount of time before repeating this process. Waiting a predetermined amount of time (e.g. one to two minutes) before repeating the process, allows for the host vehicle to come to a temporary stop (e.g. at a stop light or stop sign) without allowing the mobile device to return to normal operations.

Optionally, MCU 104 can monitor wireless network device 106 for endpoint connectivity (e.g. a connection to mobile device 102). Once a connection is established, disabling device 101 can send a wireless network signal or notification to mobile device 102.

As discussed previously, cellular radio 105, at the direction of MCU 104, can send messages/alerts, such as, for example a short message service (SMS) push notification, to monitoring party's device 111, when certain events occur. An embodiment of a portion of the method of the present invention that issues these alerts/messages is shown in FIG. 5. In operation 505 of method 500, disabling device 101 determines whether a monitoring event has occurred. If, in operation 510, a monitoring event has occurred, an alert/message will be transmitted to monitoring party's device 111 in operation 515. If, in operation 510, no monitoring event has occurred, then disabling device 101 continues checking for a monitoring event.

Monitoring events can include disabling device 101 being unplugged from a host vehicle, disabling device 101 being plugged into a host vehicle, or disabling device 101 losing external power for a predetermined amount of time while the host vehicle is running. A method of monitoring these three exemplary events (method 600) is illustrated in FIG. 6. In operation 605, disabling device 101 determines if it has been newly installed in a host vehicle. If disabling device has been newly installed, then, in operation 610, cellular radio 105 sends an alert to monitoring party's device 111 indicating that the initial installation of disabling device 101 is complete. If the disabling device has not been newly installed, then, in operation 615, disabling device 101 determines if it has been unplugged from vehicle's OBD system 110. If disabling device 101 has been unplugged from vehicles OBD system 110, then, in operation 620, cellular radio 105 sends an alert to monitoring party's device 111 indicating that disabling device 101 has been unplugged. If disabling device 101 is still plugged in, disabling device 101 determines if it has lost main power for a predetermined amount of time (e.g. two minutes) while the host vehicle is running. This can be determined by monitoring OBD interface 103 to ensure it is receiving power form vehicle's OBD system 110 and monitoring vehicle diagnostic information to ensure that the vehicle is running. If disabling device 101 has lost main power for a predetermined amount of time while the vehicle is running, cellular radio 105 sends an alert to monitoring party's device 111 indicating that disabling device 101 has lost main power. If disabling device 101 has not lost main power, then the process continues monitoring for disabling device 101 becoming unplugged (operation 615) and disabling device 101 losing main power (operation 625).

Disabling device 101 can also perform a self-test to ensure that its disabling signal is transmitting, its battery is operational and its external power is being received while the host vehicle is running. A monitoring alert can then be sent at pre-determined intervals (e.g. every 30 days) to monitoring party's device 111 indicating that disabling device 101 is functioning properly.

FIG. 7 is a block diagram showing a mobile device according to an exemplary embodiment. The exemplary mobile device includes memory 701, processor 702 and user interface module 703, which includes touch-screen display module 704 and tactile feedback module 705, all of which is described in further detail below. It should be understood, that a mobile device as illustrated and hereinafter described is merely illustrative of a mobile device that could benefit from embodiments of the invention and, therefore, should not be taken to limit the scope of the invention. While one embodiment of the mobile device is illustrated for purposes of example, other types of mobile electronic devices, such as, but not limited to, mobile phones, smart phones, portable digital assistants (PDAs), tablets, mobile computing devices, gaming devices, laptop computers, media players, and other types of mobile electronic systems, may readily employ embodiments of the invention.

An embodiment of the method of the present invention from the perspective of mobile device 102 (method 800) is illustrated in the flowchart of FIG. 8. As shown in operation 805, software running on mobile device 102 polls for a disabling signal. Once a disabling signal is received (in operation 810), the software determines if it is valid in operation 815. If the disabling signal is not valid, the software continues polling for a disabling signal in operation 805. If the disabling signal is valid, then the software alters the system configuration of mobile device 102 in operation 820 to restrict the user's ability to perform certain tasks. These tasks may include, for example, using the keyboard, or sending and/or receiving text messages and/or email messages, placing and/or receiving phone calls, or placing and/or receiving phone calls when not in hands-free mode. In operation 825, the software continues to poll for a disabling signal. In operation 830, the software determines if the same disabling signal has been received within a predetermined period of time. If it has, then the software continues to poll for a disabling signal (operation 825). If the same disabling signal has not been received within a predetermined period of time, the software restores the system configuration of mobile device 102 in operation 835.

Another embodiment of the method of the present invention from the perspective of mobile device 102 (method 900) is illustrated in the flowchart of FIG. 9. As shown in operation 905, software running on mobile device 102 polls for a disabling signal. The disabling signal includes identifiers, such as an SSID and a MAC address. Once a disabling signal is received (in operation 910), the software queries, in operation 920, a locally located list of known MAC addresses to determine, in operation 940, if the MAC address received in the disabling signal is contained in the local list. If the MAC address is not in the local list, then, in operation 945, a remotely located list of known MAC addresses is queried to determine, in operation 950, if the MAC address is contained in the remote list. If the MAC address is not contained in the remote list, the MAC address is not recognized and the software continues polling for a disabling signal in operation 905. If the MAC address is contained in the remote list, the MAC address is added to the local list in operation 955. Once a valid MAC address has been confirmed, the software alters the system configuration of mobile device 102 in operation 920 to restrict the user's ability to perform certain tasks including, for example, using the keyboard, or sending and/or receiving text messages, email messages, and/or phone calls. In operation 925, the software continues to poll for a disabling signal. In operation 930, the software determines if the same network identifier has been received within a predetermined period of time. If it has, then the software continues to poll for a disabling signal (operation 925). If the same disabling signal has not been received within a predetermined period of time, the software restores the system configuration of mobile device 102 in operation 935.

Like disabling device 101, the software running on mobile device 102 can protect itself from tampering and verify its own operable status by transmitting messages/alerts, such as, for example, a SMS push notification containing, for example, the mobile device's phone number to monitoring party's device 111. Monitoring events can include the software being installed on mobile device 102 or the software being disabled. The software running on mobile device 102 can comprise two separate apps—a primary system app and a secondary app. The primary app is monitored by a secondary app. The purpose of the secondary app is to send an alert to monitoring party device 111 in the event of removal of the primary app. The primary app also monitors the secondary app, and sends an alert to monitoring party device 111 in the event of removal of the secondary app. In this respect the primary and secondary app independently monitor each other for removal, making the app portion of the system self-protecting. Methods (methods 1000, 1015, and 1030) that issues exemplary alerts originating from mobile device 102 are shown in FIG. 10.

Method 1000 determines, in operation 1005, if the primary app and the secondary app have been newly installed on mobile device 102. If the software has been newly installed, then, in operation 1010, mobile device 102 sends an alert to monitoring party's device 111 indicating that the software installation has been completed.

Method 1015 determines, in operation 1020, if the primary app or the secondary app has been removed. If either app has been removed, then, in operation 1025, an alert is sent to monitoring party's device 111 indicating that the primary app or secondary app (as applicable) has been removed.

Method 1030 determines, in operation 1035, if mobile device 102 has received a disabling signal. If no disabling signal has been received, then the software continues to wait for the disabling signal to arrive. If a disabling signal has been received, then, in operation 1040, the software determines if it is the first time mobile device 102 is receiving the disabling signal. If this is not the first time mobile device 102 has received a disabling signal, then the system configuration of mobile device 102 is altered in operation 1050. If this is the first time mobile device 102 has received a disabling signal, then, in operation 1045, an alert is sent to monitoring party's device 111 indicating that the software installation and communication with disabling device 102 has completed. The system configuration of mobile device 102 is then altered in operation 1050. After mobile device 102's system configuration has been altered, the software, in operation 1055, determines if a predetermined amount of time (e.g. 2 minutes) has lapsed since mobile device 102 received a disabling signal. If not, then the software continues polling for a disabling signal in operation 1035. If the predetermined amount of time has lapsed then the software restores the system configuration of mobile device 102 in operation 1060.

The software running on mobile device 102 can also perform a self-test to ensure that it is receiving disabling signals at expected intervals (e.g. every 15 seconds or twice within any 30 second window) and it is altering mobile device 102's system configuration upon receipt of a valid disabling signal. A monitoring alert can then be sent at pre-determined intervals (e.g. every 30 days) to monitoring party's device 111 indicating that the software running on mobile device 102 is functioning properly.

The following are exemplary scenarios demonstrating pre-operational functionality of embodiments of the present invention.

Disabling device set-up—disabling device intact and not in vehicle:

Interface: Inactive

Battery: Inactive (charged)

MCU: Inactive

Wireless Network Radio: Inactive

Cellular Radio: Inactive

Disabling device Installed—vehicle is running but transmission not engaged:

Interface: Pulls power (e.g. 12V) from vehicle's OBD system and converts OBD II signal into UART/SPI

Battery: Inactive (charging)

MCU: Recognizes connectivity to OBD II port via internal programming, physical switch or software switch and initiates a monitoring alert (e.g. push notification); analyzes signal from OBD II interface for operational status

Wireless Network Radio: Inactive

Cellular Radio: Transmits monitoring ‘Disabling device installed’ alert to monitoring party's device

Vehicle not running; Disabling device intact:

Interface: Inactive

Battery: Inactive (charged)

MCU: Inactive

Wireless Network Radio: Inactive

Cellular Radio: Inactive

Disabling device is unplugged:

Interface: Unplugged and inactive

Battery: Active (discharging) Powers MCU and cellular radio

MCU: Recognizes lack of connectivity to OBD II port via internal programming, physical switch or software switch, engages battery and initiates monitoring alert indicating that disabling device has been disconnected

Wireless Network Radio: Inactive

Cellular Radio: Transmits monitoring alert (e.g. push notification) indicating that disabling device has been disconnected to monitoring party's device

The following are exemplary scenarios demonstrating operational functionality of embodiments of the present invention.

Vehicle running but transmission is not engaged (non-operational); disabling device installed:

Interface: Pulls power (e.g. 12V) from vehicle's OBD system and converts OBD II signal into UART/SPI

Battery: Inactive (charging)

MCU: Recognizes connectivity to OBD II port via internal programming, physical switch or software switch; analyzes signal from OBD II interface for operational status

Wireless Network Radio: Inactive

Cellular Radio: Inactive

Vehicle running and transmission is engaged (operational); disabling device installed (normal operating mode)

Interface: Pulls (e.g. 12V) from vehicle's OBD system and converts OBD II signal into UART/SPI

Battery: Inactive (charging)

MCU: Recognizes connectivity to OBD II port via internal programming, physical switch, or software switch; analyzes signal from OBD II interface for operational status

Wireless Network Radio: Sends disabling signal (e.g. encrypted SSID signal) nominally every 20 seconds

Cellular Radio: Inactive

Vehicle running and transmission is engaged (operational); disabling device Installed; power from vehicle's OBD system is unavailable for a predetermined period of time (e.g. 120 seconds)

Interface: Converts OBD II signal into UART/SPI

Battery: Active (not charging); Powers MCU and cellular radio

MCU: Recognizes connectivity to OBD II port via internal programming, physical switch or software switch; analyzes signal from OBD II interface for operational status; recognizes power from vehicle's OBD system is unavailable for predetermined period of time (e.g. two minutes); initiates monitoring alert (e.g. push notification) indicating no external power to the disabling device for a defined time period

Wireless Network Radio: Inactive p Cellular Radio: Transmits monitoring alert to monitoring party's device

Exemplary Electronic Devices—Mobile Device and Disabling Device

FIGS. 1 and 7 are block diagrams illustrating exemplary embodiments of disabling device 101 and mobile device 102, respectively. It should be understood these exemplary embodiments are merely illustrative of disabling device and a mobile device that could benefit from embodiments of the invention and, therefore, should not be taken to limit the scope of the invention. Moreover, the apparatus of an example embodiment need not be the entire device, but may be a component or group of components of the device in other example embodiments.

Regarding mobile devices, devices may readily employ embodiments of the invention regardless of their intent to provide mobility. In this regard, even though embodiments of the invention are described in conjunction with a mobile device, it should be understood that embodiments of the invention may be utilized in conjunction with a variety of other electronic devices.

The devices may each comprise a processor or other processing circuitry. As used in this application, the term ‘circuitry’ refers to at least all of the following: hardware-only implementations (such as implementations in only analog and/or digital circuitry) and to combinations of circuits and software and/or firmware such as to a combination of processors or portions of processors/software including digital signal processor(s), software, and memory(ies) that work together to cause an apparatus, such as a mobile phone or tablet, to perform various functions and to circuits, such as a microprocessor(s) or portion of a microprocessor(s), that require software or firmware for operation, even if the software or firmware is not physically present. This definition of ‘circuitry’ applies to all uses of this term in this application, including in any claims.

As a further example, as used in this application, the term “circuitry” would also cover an implementation of merely a processor, multiple processors, or portion of a processor and its (or their) accompanying software and/or firmware.

Further, the processor(s) may comprise functionality to operate one or more software programs, which may be stored in memory and which may, among other things, cause the processor to implement at least one embodiment including, for example, one or more of the functions described above. The mobile device may comprise a user interface for providing output and/or receiving input. The mobile device may comprise an output device such as a ringer, a conventional earphone and/or speaker, a microphone, a display, and/or a user input interface, which are coupled to the processor. The user input interface, which allows the electronic device to receive data, may comprise means, such as one or more devices that may allow the electronic device to receive data, such as a keypad, a touch display, for example if the display comprises touch capability, and/or the like.

The devices may comprise a memory device including, in one embodiment, volatile memory, such as volatile Random Access Memory (RAM) including a cache area for the temporary storage of data. The devices may also comprise other memory, for example, non-volatile memory, which may be embedded and/or may be removable. The non-volatile memory may comprise an EEPROM, flash memory or the like. The memories may store any of a number of pieces of information, and data. The information and data may be used by the devices to implement one or more functions of the devices.

Although FIGS. 1 and 7 illustrate an example of a disabling device and mobile device, respectively, that may utilize embodiments of the invention including those described and depicted, for example, in FIGS. 3 through 6 for the disabling device and in FIGS. 8 through 10 for the mobile device, the disabling device of FIG. 1 and the mobile device of FIG. 7 are each merely an example of devices that may utilize embodiments of the invention.

Embodiments of the invention may be implemented in software, hardware, application logic or a combination of software, hardware, and application logic. The software application logic and/or hardware may reside on the apparatus, a separate device, or a plurality of separate devices. If desired, part of the software application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any tangible media or means that can contain, or store the instructions for use by or in connection with an instruction execution system, apparatus, or device, such as a computer, with two examples of a computer described and depicted in FIGS. 1 and 7. A computer readable medium may comprise a computer-readable storage medium that may be any tangible media or means that can contain or store the instructions for use by or in connection with an instruction execution system, apparatus, or device, such as a computer.

Alternative embodiments of the present invention include use of the app for altering the system configuration of mobile device that enter a certain area. For example, the app could be installed on mobile devices of employees of a certain workplace or on the mobile devices of students of a school to avoid distracting features of the mobile device such as texting, internet, or photography. The disabling signal would be transmitted by an existing or previously installed wireless network device as described above; however, the mechanism triggering the disabling signal would be, for example, an physical on/off switch or a software timer that turned the disabling signal on and off at certain times of the day, rather than vehicle diagnostics from a vehicle's OBD system. The app would query a list, or whitelist, of media access control (MAC) addresses to determine if a received disabling signal is coming from a valid source as described previously. Alerts such as the removal of the primary app or secondary app would be communicated to a monitoring party (such as the workplace owner) device as described previously.

Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

What is claimed is:

1. A method of limiting mobile device functionality in a vehicle having an on-board diagnostic system comprising:
receiving, at a disabling device in communication with the on-board diagnostic system and a mobile device, a vehicle diagnostic signal from the on-board diagnostic system;
determining the vehicle's operational status from the vehicle diagnostic signal;
continuously receiving the vehicle diagnostic and determining the vehicle's operational status, responsive to the vehicle's operational status being non-operational; and
transmitting a disabling signal to the mobile device as long as the vehicle's operational status is operational, whereby the disabling signal limits the functionality of the mobile device.

2. The method of claim 1 wherein the operational status is the vehicle's transmission status.

3. The method of claim 1, further comprising:
transmitting an alert to a monitoring party's device when a monitoring event occurs.

4. The method of claim 3, wherein the monitoring event is when the disabling device becomes unplugged.

5. The method of claim 3, wherein the monitoring event is when the disabling device loses power from an external power source for a predetermined period of time when the vehicle's operational status is operational.

6. The method of claim 1, further comprising:
polling, at the mobile device, for the disabling signal from the disabling device;
receiving, at the mobile device, a disabling signal; and
altering the mobile device's system configuration responsive to the disabling signal being valid.

7. The method of claim 6, further comprising:
receiving, at the mobile device, a second disabling signal; and
determining if the disabling signal is valid; and
restoring the mobile device's system configuration responsive to the second disabling signal being invalid.

8. A method of limiting mobile device functionality in a vehicle having an on-board diagnostic system in communication with a disabling device comprising:
polling, at a mobile device, for a disabling signal from the disabling device;
receiving a disabling signal;
determining if the disabling signal is valid;
altering the mobile device's system configuration responsive to the disabling signal being valid;
polling for the disabling signal;
restoring the mobile device's system configuration responsive to not receiving the disabling signal after a pre-determined amount of time.

9. The method of claim 8, wherein the disabling signal is a network identifier.

10. The method of claim 9, wherein the network identifier is an SSID.

11. The method of claim 8, wherein altering the mobile device's system configuration comprises restricting the mobile device's ability to send and receive text messages and emails.

12. The method of claim 8, wherein altering the mobile device's system configuration comprises restricting the mobile device's ability to place and receive phone calls.

13. The method of claim 8, further comprising:
transmitting an alert to a monitoring party's device when the mobile device's ability to limit mobile device functionality in an operating vehicle is tampered with or disabled.

14. A device for limiting mobile device functionality in a vehicle having an on-board diagnostic system comprising:
an on-board diagnostic interface capable of communicating with the on-board diagnostic system;
a microcontroller in communication with the on-board diagnostic interface, wherein the microcontroller receives a vehicle diagnostic from the on-board diagnostic system through the on-board diagnostic interface; and
a wireless network radio in communication with the microcontroller, wherein the wireless network radio transmits a disabling signal responsive to receipt of the vehicle diagnostic indicating that the vehicle's operational status is operational.

15. The device of claim 14, further comprising:
a cellular radio in communication with the microcontroller, wherein the cellular radio transmits an alert to a monitoring party's device when the microcontroller detects a monitoring event has occurred.

16. The device of claim 14, further comprising:
an on-board diagnostic tool interface in communication with the on-board diagnostic interface.

17. A system of limiting mobile device functionality in a vehicle having an on-board diagnostic system comprising:
a disabling device having an on-board diagnostic interface capable of communicating with the on-board diagnostic system, a microcontroller in communication with the on-board diagnostic interface, wherein the microcontroller receives a vehicle diagnostic from the on-board diagnostic system through the on-board diagnostic interface, a wireless network radio in communication with the microcontroller, wherein the wireless network radio transmits a disabling signal responsive to receipt of a vehicle diagnostic indicating that the vehicle's operational status is operational; and
a mobile device for receiving the disabling signal, wherein software residing on the mobile device alters the mobile device's system configuration.

18. The system of claim 17, wherein the software residing on the mobile device alters the mobile device's system configuration to restrict the mobile device's ability to send and receive text messages and email messages.

19. The system of claim 17, wherein the disabling device further comprises a cellular radio in communication with the microcontroller, wherein the cellular radio transmits an alert when a monitoring event has occurred.

20. The system of claim 18, further comprising:
a monitoring party's device for receiving the alert from the cellular radio.

21. The system of claim 17, wherein the disabling device further comprises an on-board diagnostic tool interface in communication with the on-board diagnostic interface.
